(19) United States
(12) Patent Application Publication
(10) Pub. No.: US 2020/0090266 A1
(43) Pub. Date: Mar. 19, 2020

(54) System, Method, and Computer Program Product for Determining a Creditworthiness Score of a Merchant Based on Similar Merchants

(71) Applicant: Visa International Service Association, San Francisco, CA (US)

(72) Inventors: Adam Allan Stern, Sunny Isles Beach, FL (US); Cesar Alejandro Rebollar Trejo, Miami, FL (US); Enrique Luis Pardo Sucre, Miami, FL (US); Luis Armando Michelangeli, Doral, FL (US); Stephanie Michelle Zangroniz Miranda, Miami, FL (US)

(21) Appl. No.: 16/571,700

(22) Filed: Sep. 16, 2019

Related U.S. Application Data
(60) Provisional application No. 62/731,192, filed on Sep. 14, 2018.

(51) Int. Cl. G06Q 40/02; G06Q 10/06

(52) U.S. Cl. CPC G06Q 40/025; G06Q 10/06393

(57) ABSTRACT

Provided is a computer-implemented method for determining creditworthiness of a merchant based on one or more similar merchants. The method includes receiving merchant data associated with a first merchant, identifying one or more second merchants that are similar to the first merchant based on a threshold, generating a creditworthiness score of the one or more second merchants based on merchant creditworthiness data associated with payment transactions involving the one or more second merchants, and transmitting information associated with the creditworthiness score of the one or more second merchants to a computer device. A system and computer program product are also disclosed.

### CROSS REFERENCE TO RELATED APPLICATION

This application claims the benefit of U.S. Provisional Patent Application No. 62/731,192, filed on Sep. 14, 2018, the disclosure of which is hereby incorporated by reference in its entirety.

### BACKGROUND

### 1. Field

This disclosure relates generally to determining creditworthiness of a merchant and, in one particular embodiment, to a system, method, and computer program product for determining a creditworthiness score of a merchant based on similar merchants.

### 2. Technical Considerations

A merchant may include one or more entities (e.g., operators of retail businesses) that provide goods and/or services, and/or access to goods and/or services, to a user (e.g., a customer, a consumer, and/or the like) based on a transaction, such as a payment transaction. An acquirer (e.g., an acquiring bank) may be a financial institution that processes payment transactions on behalf of a merchant. For example, the acquirer may allow for a merchant to accept a payment via a credit card from an issuer institution (e.g., a credit card issuing bank) based on the acquirer processing a payment transaction involving the credit card. The acquirer may enter into a contract with a merchant and provides the merchant with a merchant account and the merchant account provides the merchant with a line of credit.

However, a financial services entity, such as financial institution (e.g., a lender, an acquirer, and/or the like) or a financial technology entity (e.g., a Fintech), may be reluctant to provide the merchant a merchant account, a financial product (e.g. credit card), or a loan due to a limited amount of information associated with creditworthiness of the merchant. For example, an acquirer may be reluctant to provide the merchant a merchant account where the merchant does not have an adequate data associated with a credit history of the merchant (e.g., no credit score, a credit score that does not satisfy a threshold, a limited amount of data associated with payment transactions involving the merchant, and/or the like) to determine a creditworthiness score of the merchant. In addition, the acquirer may not have access to data associated with the credit history of the merchant. For example, the acquirer may not have access to a database and/or the acquirer may not have a technological infrastructure to create such a database.

### SUMMARY

Accordingly, disclosed are systems, methods, and computer program products for determining a creditworthiness score of a merchant based on one or more similar merchants.

According to some non-limiting aspects or embodiments, provided is a computer-implemented method, for determining a creditworthiness score of a merchant based on one or more similar merchants comprising: receiving, with at least one processor, a request regarding a first merchant; identifying, with at least one processor, one or more second merchants that are similar to the first merchant based on a threshold; generating, with at least one processor, a creditworthiness score of the one or more second merchants based on merchant creditworthiness data associated with payment transactions involving the one or more second merchants; and transmitting, with at least one processor, information associated with the creditworthiness score of the one or more second merchants to a computer device.

According to some non-limiting aspects or embodiments, provided is a system for determining a creditworthiness score of a merchant based on one or more similar merchants comprising: at least one processor programmed or configured to: receive merchant data associated with a first merchant; identify one or more second merchants that are similar to the first merchant; generate a creditworthiness score of the one or more second merchants based on merchant creditworthiness data associated with payment transactions involving the one or more second merchants; and transmit information associated with the creditworthiness score of the one or more second merchants to a computer device.

According to some non-limiting aspects or embodiments, provided is a computer program product for determining a creditworthiness score of a merchant based on one or more similar merchants comprising at least one non-transitory computer-readable medium comprising one or more instructions that, when executed by at least one processor, cause the at least one processor to: receive merchant data associated with a first merchant; identify one or more second merchants that are similar to the first merchant; generate a creditworthiness score of the one or more second merchants based on merchant creditworthiness data associated with payment transactions involving the one or more second merchants; and transmit information associated with the creditworthiness score of the one or more second merchants to a computer device.

Further non-limiting aspects or embodiments are set forth in the following numbered clauses:

Clause 1: A computer-implemented method, for determining a creditworthiness score of a merchant based on one or more similar merchants comprising: receiving, with at least one processor, a request regarding a first merchant; identifying, with at least one processor, one or more second merchants that are similar to the first merchant based on a threshold; generating, with at least one processor, a creditworthiness score of the one or more second merchants based on merchant creditworthiness data associated with payment transactions involving the one or more second merchants; and transmitting, with at least one processor, information associated with the creditworthiness score of the one or more second merchants to a computer device.

Clause 2: The method of clause 1, wherein the merchant data associated with the first merchant comprises: data associated with a time interval during which the first merchant has been active; data associated with a merchant type of the first merchant; data associated with a merchant location of the first merchant; data associated with an average transaction amount of payment transactions involving the first merchant; data associated with a number of payment transactions involving the first merchant during the time interval; data associated with an overall transaction amount of payment transactions involving the first merchant during the time interval; or any combination thereof.

Clause 3: The method of clauses 1 or 2, wherein the merchant creditworthiness data comprises: data associated with payment flows of the one or more second merchants; data associated with chargebacks of the one or more second merchants; data associated with a fraud rate of the one or more second merchants; data associated with a growth rate of the one or more second merchants; data associated with a default rate of the one or more second merchants; data associated with a payment behavior of the one or more second merchants; or any combination thereof.

Clause 4: The method of any of clauses 1-3, wherein receiving the merchant data associated with the first merchant comprises: retrieving the merchant data associated with the first merchant from a database associated with a transaction service provider system.

Clause 5: The method of any of clauses 1-4, further comprising: generating a creditworthiness score for the first merchant based at least partially on the creditworthiness score of the one or more second merchants.

Clause 6: The method of any of clauses 1-5, wherein identifying the one or more second merchants that are similar to the first merchant based on the threshold comprises: identifying the one or more second merchants that are similar to the first merchant based on at least one of the following: a threshold of time during which the one or more second merchants has been active; a threshold merchant type of the one or more second merchants; a threshold of distance of a merchant location of the one or more second merchants from a location associated with the merchant location of the first merchant; a threshold of an average transaction amount of payment transactions involving the one or more second merchants during a time interval; a threshold of a number of payment transactions involving the one or more second merchants during a time interval; or a threshold of an overall transaction amount of payment transactions involving the one or more second merchants during a time interval.

Clause 7: The method of any of clauses 1-6, further comprising: determining, based on the merchant data associated with the first merchant, at least one the following: the threshold of time during which the one or more second merchants has been active; the threshold merchant type of the one or more second merchants; the threshold of distance of the merchant location of the one or more second merchants from the location associated with the merchant location of the first merchant; the threshold of an average transaction amount of payment transactions involving the one or more second merchants during a time interval; the threshold of a number of payment transactions involving the one or more second merchants during a time interval; or the threshold of the overall transaction amount of payment transactions involving the one or more second merchants during a time interval.

Clause 8: A system for determining a creditworthiness score of a merchant based on one or more similar merchants comprising: at least one processor programmed or configured to: receive merchant data associated with a first merchant; identify one or more second merchants that are similar to the first merchant; generate a creditworthiness score of the one or more second merchants based on merchant creditworthiness data associated with payment transactions involving the one or more second merchants; and transmit information associated with the creditworthiness score of the one or more second merchants to a computer device.

Clause 9: The system of clause 8; wherein the merchant data associated with the first merchant comprises: data associated with a time interval during which the first merchant has been active; data associated with a merchant type of the first merchant; data associated with a merchant location of the first merchant; data associated with an average transaction amount of payment transactions involving the first merchant; data associated with a number of payment transactions involving the first merchant during the time interval; data associated with an overall transaction amount of payment transactions involving the first merchant during the time interval; or any combination thereof.

Clause 10: The system of clauses 8 or 9, wherein the merchant creditworthiness data comprises: data associated with payment flows of the one or more second merchants; data associated with chargebacks of the one or more second merchants; data associated with a fraud rate of the one or more second merchants; data associated with a growth rate of the one or more second merchants; data associated with a default rate of the one or more second merchants; data associated with a payment behavior of the one or more second merchants; or any combination thereof.

Clause 11: The system of any of clauses 8-10, wherein, when receiving the merchant data associated with the first merchant, the at least one processor is programmed or configured to: retrieve the merchant data associated with the first merchant from a database associated with a transaction service provider system.

Clause 12: The system of any of clauses 8-11, wherein the at least one processor is further programmed or configured to: generate a creditworthiness score for the first merchant based at least partially on the creditworthiness score of the one or more second merchants.

Clause 13: The system of any of clauses 8-12, wherein, when identifying the one or more second merchants that are similar to the first merchant, the at least one processor is programmed or configured to: identify the one or more second merchants that are similar to the first merchant based on at least one of the following: a threshold of time during which the one or more second merchants has been active; a threshold merchant type of the one or more second merchants; a threshold of distance of a merchant location of the one or more second merchants from a location associated with the merchant location of the first merchant; a threshold of an average transaction amount of payment transactions involving the one or more second merchants during a time interval; a threshold of a number of payment transactions involving the one or more second merchants during a time interval; or a threshold of an overall transaction amount of payment transactions involving the one or more second merchants during a time interval.

Clause 14: The system of any of clauses 8-13, wherein the at least one processor is further programmed or configured to: determine, based on the merchant data associated with the first merchant, at least one the following: the threshold of time during which the one or more second merchants has been active; the threshold merchant type of the one or more second merchants; the threshold of distance of the merchant location of the one or more second merchants from the location associated with the merchant location of the first merchant; the threshold of an average transaction amount of payment transactions involving the one or more second merchants during a time interval; the threshold of a number of payment transactions involving the one or more second merchants during a time interval; or the threshold of the overall transaction amount of payment transactions involving the one or more second merchants during a time interval.

Clause 15: A computer program product for determining a creditworthiness score of a merchant based on one or more similar merchants comprising at least one non-transitory computer-readable medium comprising one or more instructions that, when executed by at least one processor, cause the at least one processor to: receive merchant data associated with a first merchant; identify one or more second merchants that are similar to the first merchant; generate a creditworthiness score of the one or more second merchants based on merchant creditworthiness data associated with payment transactions involving the one or more second merchants; and transmit information associated with the creditworthiness score of the one or more second merchants to a computer device.

Clause 16: The computer program product of clause 15, wherein, the one or more instructions that cause the at least one processor to receive the merchant data associated with the first merchant, cause the at least one processor to: retrieve the merchant data associated with the first merchant from a database associated with a transaction service provider system.

Clause 17: The computer program product of clauses 15 or 16, wherein the one or more instructions further cause the at least one processor to: generate a creditworthiness score for the first merchant based at least partially on the creditworthiness score of the one or more second merchants.

Clause 18: The computer program product of any of clauses 15-17, wherein, the one or more instructions that cause the at least one processor to identify the one or more second merchants that are similar to the first merchant, cause the at least one processor to: identify the one or more second merchants that are similar to the first merchant based on at least one of the following: a threshold of time during which the one or more second merchants has been active; a threshold merchant type of the one or more second merchants; a threshold of distance of a merchant location of the one or more second merchants from a location associated with the merchant location of the first merchant; a threshold of an average transaction amount of payment transactions involving the one or more second merchants during a time interval; a threshold of a number of payment transactions involving the one or more second merchants during a time interval; or a threshold of an overall transaction amount of payment transactions involving the one or more second merchants during a time interval.

Clause 19: The computer program product of any of clauses 15-18, wherein the one or more instructions further cause the at least one processor to: determine, based on the merchant data associated with the first merchant, at least one the following: the threshold of time during which the one or more second merchants has been active; the threshold merchant type of the one or more second merchants; the threshold of distance of the merchant location of the one or more second merchants from the location associated with the merchant location of the first merchant; the threshold of an average transaction amount of payment transactions involving the one or more second merchants during a time interval; the threshold of a number of payment transactions involving the one or more second merchants during a time interval; or the threshold of the overall transaction amount of payment transactions involving the one or more second merchants during a time interval.

Clause 20: The computer program product of any of clauses 15-19, wherein the merchant data associated with the first merchant comprises: data associated with a time interval during which the first merchant has been active; data associated with a merchant type of the first merchant; data associated with a merchant location of the first merchant; data associated with an average transaction amount of payment transactions involving the first merchant; data associated with a number of payment transactions involving the first merchant during the time interval; data associated with an overall transaction amount of payment transactions involving the first merchant during the time interval; or any combination thereof.

The features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and the claims, the singular form of “a,” “an,” and “the” include plural referents unless the context clearly dictates otherwise.

### BRIEF DESCRIPTION OF THE DRAWINGS

Additional advantages and details of the disclosure are explained in greater detail below with reference to the exemplary embodiments that are illustrated in the accompanying schematic figures, in which:

FIG. 1 is a diagram of a non-limiting embodiment of an environment in which systems, apparatuses, and/or methods, as described herein, may be implemented;

FIG. 2 is a diagram of a non-limiting embodiment of components of one or more devices of FIG. 1; and

FIG. 3 is a flowchart illustrating a non-limiting embodiment of a method for determining creditworthiness of a merchant based on one or more similar merchants.

### DESCRIPTION OF THE PREFERRED EMBODIMENTS

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects of the embodiments disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some non-limiting embodiments, a message may refer to a network packet (e.g., a data packet and/or the like) that includes data. It will be appreciated that numerous other arrangements are possible.

As used herein, the terms “issuer institution,” “payment device issuer,” “issuer,” or “issuer bank” may refer to one or more entities that provide accounts to customers for conducting transactions (e.g., payment transactions), such as initiating credit and/or debit payments. For example, an issuer institution may provide an account identifier, such as a primary account number (PAN), to a customer that uniquely identifies one or more accounts associated with that customer. The account identifier may be embodied on a payment device, such as a physical payment instrument (e.g., a payment card), and/or may be electronic and used for electronic payments. In some non-limiting embodiments, an issuer institution may be associated with a bank identification number (BIN) that uniquely identifies the issuer institution. As used herein, the term “issuer institution system” may refer to one or more computer systems operated by or on behalf of an issuer institution, such as a server executing one or more software applications. For example, an issuer institution system may include one or more authorization servers for authorizing a transaction.

As used herein, the term “account identifier” may refer to one or more types of identifiers associated with a user account (e.g., an account identifier, a PAN, a card number, a payment card number, a token, and/or the like). In some non-limiting embodiments, an issuer institution may provide an account identifier (e.g., a PAN, a token, and/or the like) to a user that uniquely identifies one or more accounts associated with that user. The account identifier may be embodied on a payment instrument (e.g., a payment card, a credit card, a debit card, and/or the like) and/or may be electronic information transmitted to the user that the user may use for electronic payments. In some non-limiting embodiments, the account identifier may be an original account identifier, where the original account identifier was provided to a user at the creation of the account associated with the account identifier. In some non-limiting embodiments, the account identifier may be an account identifier (e.g., a supplemental account identifier) that is provided to a user after the original account identifier was provided to the user. For example, if the original account identifier is forgotten, stolen, and/or the like, a supplemental account identifier may be provided to the user. In some non-limiting embodiments, an account identifier may be directly or indirectly associated with an issuer institution such that an account identifier may be a token that maps to a PAN or other type of identifier. Account identifiers may be alphanumeric, any combination of characters and/or symbols, and/or the like.

As used herein, the term “token” may refer to an identifier that is used as a substitute or replacement identifier for an account identifier, such as a PAN. A token may be used as a substitute or replacement identifier for an original account identifier, such as a PAN. Tokens may be associated with a PAN or other original account identifier in one or more data structures (e.g., one or more databases and/or the like) such that they may be used to conduct a transaction without directly using the original account identifier. In some non-limiting embodiments, an original account identifier, such as a PAN, may be associated with a plurality of tokens for different individuals or purposes. In some non-limiting embodiments, tokens may be associated with a PAN or other account identifiers in one or more data structures such that they can be used to conduct a transaction without directly using the account identifier, such as a PAN. In some examples, an account identifier, such as a PAN, may be associated with a plurality of tokens for different uses or different purposes.

As used herein, the term “merchant” may refer to one or more entities (e.g., operators of retail businesses) that provide goods and/or services, and/or access to goods and/or services, to a user (e.g., a customer, a consumer, and/or the like) based on a transaction, such as a payment transaction. As used herein, the term “merchant system” may refer to one or more computer systems operated by or on behalf of a merchant, such as a server executing one or more software applications. As used herein, the term “product” may refer to one or more goods and/or services offered by a merchant.

As used herein, the term “point-of-sale (POS) device” may refer to one or more devices, which may be used by a merchant to conduct a transaction (e.g., a payment transaction) and/or process a transaction. For example, a POS device may include one or more computers, peripheral devices, card readers, near-field communication (NFC) receivers, radio frequency identification (RFID) receivers, and/or other contactless transceivers or receivers, contact-based receivers, payment terminals, computers, servers, input devices, and/or the like.

As used herein, the term “point-of-sale (POS) system” may refer to one or more computers and/or peripheral devices used by a merchant to conduct a transaction. For example, a POS system may include one or more POS devices and/or other like devices that may be used to conduct a payment transaction. A POS system (e.g., a merchant POS system) may also include one or more server computers programmed or configured to process online payment transactions through webpages, mobile applications, and/or the like.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa®, MasterCard®, American Express®, or any other entity that processes transactions. As used herein, the term “transaction service provider system” may refer to one or more computer systems operated by or on behalf of a transaction service provider, such as a transaction service provider system executing one or more software applications. A transaction service provider system may include one or more processors and, in some non-limiting embodiments, may be operated by or on behalf of a transaction service provider.

As used herein, the term “acquirer” may refer to an entity licensed by the transaction service provider and approved by the transaction service provider to originate transactions (e.g., payment transactions) using a payment device associated with the transaction service provider. As used herein, the term “acquirer system” may also refer to one or more computer systems, computer devices, and/or the like operated by or on behalf of an acquirer. The transactions the acquirer may originate may include payment transactions (e.g., purchases, original credit transactions (OCTs), account funding transactions (AFTs), and/or the like). In some non-limiting embodiments, the acquirer may be authorized by the transaction service provider to assign merchant or service providers to originate transactions using a payment device of the transaction service provider. The acquirer may contract with payment facilitators to enable the payment facilitators to sponsor merchants. The acquirer may monitor compliance of the payment facilitators in accordance with regulations of the transaction service provider. The acquirer may conduct due diligence of the payment facilitators and ensure proper due diligence occurs before signing a sponsored merchant. The acquirer may be liable for all transaction service provider programs that the acquirer operates or sponsors. The acquirer may be responsible for the acts of the acquirer's payment facilitators, merchants that are sponsored by the acquirer's payment facilitators, and/or the like. In some non-limiting embodiments, an acquirer may be a financial institution, such as a bank.

As used herein, the term “payment device” may refer to a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet application, a personal digital assistant (PDA), a pager, a security card, a computer, an access card, a wireless terminal, and/or a transponder, as examples. The payment device may include a volatile or a non-volatile memory to store information (e.g., an account identifier, a name of the account holder, and/or the like).

As used herein, the terms “client” and “client device” may refer to one or more client-side devices or systems, remote from a transaction service provider, used to initiate or facilitate a transaction. As an example, a “client device” may refer to one or more POS devices and/or POS systems used by a merchant. It will be appreciated that a client device may be any electronic device configured to communicate with one or more networks and initiate or facilitate transactions such as, but not limited to, one or more computers, portable computers, tablet computers, cellular phones, wearable devices (e.g., watches, glasses, lenses, clothing, and/or the like), PDAs, and/or other like devices. Moreover, a “client” may also refer to an entity, such as a merchant, that owns, utilizes, and/or operates a client device for initiating transactions with a transaction service provider.

As used herein, the term “server” may refer to one or more computing devices, such as processors, storage devices, and/or similar computer components that communicate with client devices and/or other computing devices over a network, such as the Internet or private networks, and, in some examples, facilitate communication among other servers and/or client devices. It will be appreciated that various other arrangements are possible. As used herein, the term “system” may refer to one or more computing devices or combinations of computing devices, such as but not limited to processors, servers, client devices, software applications, and/or other like components. In addition, reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

Non-limiting embodiments of the present disclosure are directed to systems, methods, and computer program products for determining a creditworthiness score of a merchant based on one or more similar merchants. In one embodiment, a method may include receiving merchant data associated with a first merchant, identifying one or more second merchants that are similar to the first merchant based on a threshold, generating a creditworthiness score of the one or more second merchants based on merchant creditworthiness data associated with payment transactions involving the one or more second merchants, and transmitting information associated with the creditworthiness score of the one or more second merchants to a computer device. In this way, a financial services entity (e.g., a financial institution, such as an acquirer, a Fintech, and/or the like) may be able to determine a creditworthiness score of a merchant.

In this way, non-limiting embodiments of the present disclosure allow a financial services entity, to determine a creditworthiness score of a merchant. For example, the financial services entity may have access to data associated with a creditworthiness of the merchant based on merchant data associated with one or more merchants that are similar to the merchant. The financial services entity may be able to provide the merchant with financial products, such as a loan and/or a merchant account, based on a creditworthiness score of the merchant.

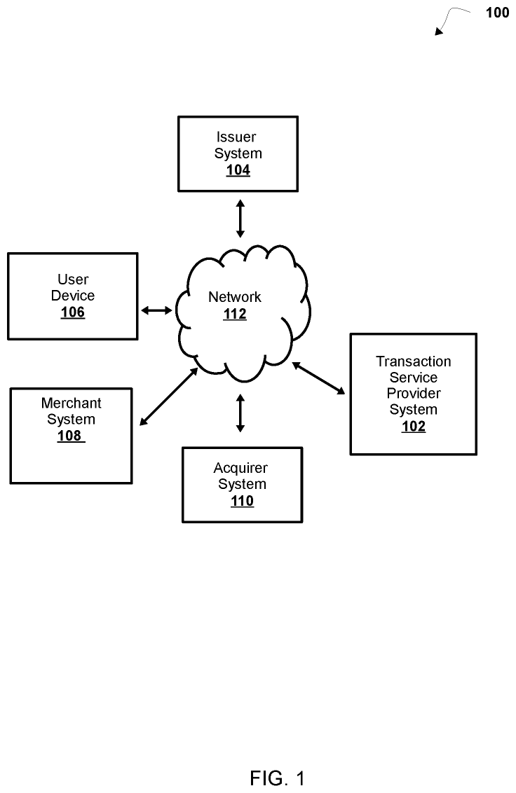

Referring now to FIG. 1, FIG. 1 is a diagram of an example environment 100 in which devices, systems, and/or methods, described herein, may be implemented. As shown in FIG. 1, environment 100 includes transaction service provider system 102, issuer system 104, user device 106, merchant system 108, acquirer system 110, and network 112.

Transaction service provider system 102 may include one or more devices capable of receiving information from and/or transmitting information to issuer system 104, user device 106, merchant system 108, and/or acquirer system 110 via network 112. For example, transaction service provider system 102 may include a computing device, such as a server (e.g., a transaction processing server), a group of servers, and/or other like devices. In some non-limiting embodiments, transaction service provider system 102 may be associated with a transaction service provider as described herein. In some non-limiting embodiments, transaction service provider system 102 may be in communication with a data storage device, which may be local or remote to the transaction service provider system 102. In some non-limiting embodiments, transaction service provider system 102 may be capable of receiving information from, storing information in, transmitting information to, or searching information stored in a data storage device.

Issuer system 104 may include one or more devices capable of receiving information and/or transmitting information to transaction service provider system 102, user device 106, merchant system 108, and/or acquirer system 110 via network 112. For example, issuer system 104 may include a computing device, such as a server, a group of servers, and/or other like devices. In some non-limiting embodiments, issuer system 104 may be associated with an issuer institution as described herein. For example, issuer system 104 may be associated with an issuer institution that issued a credit account, debit account, credit card, debit card, and/or the like to a user associated with user device 106.

User device 106 may include one or more devices capable of receiving information from and/or transmitting information to transaction service provider system 102, issuer system 104, merchant system 108, and/or acquirer system 110 via network 112. For example, user device 106 may include a client device and/or the like. In some non-limiting embodiments, user device 106 may or may not be capable of receiving information (e.g., from merchant system 108) via a short range wireless communication connection (e.g., an NFC communication connection, an RFID communication connection, a Bluetooth® communication connection, and/or the like), and/or transmitting information (e.g., to merchant system 108) via a short range wireless communication connection.

Merchant system 108 may include one or more devices capable of receiving information from and/or transmitting information to transaction service provider system 102, issuer system 104, user device 106, and/or acquirer system 110 via network 112. Merchant system 108 may also include a device capable of receiving information from user device 106 via network 112, a communication connection (e.g., an NFC communication connection, an RFID communication connection, a Bluetooth® communication connection, and/or the like) with user device 106, and/or the like, and/or transmitting information to user device 106 via the network, the communication connection, and/or the like. In some non-limiting embodiments, merchant system 108 may include a computing device, such as a server, a group of servers, a client device, a group of client devices, and/or other like devices. In some non-limiting embodiments, merchant system 108 may be associated with a merchant as described herein. In some non-limiting embodiments, merchant system 108 may include one or more user devices 106. For example, merchant system 108 may include user device 106 that allows a merchant to communicate information to transaction service provider system 102. In some non-limiting embodiments, merchant system 108 may include one or more devices, such as computers, computer systems, and/or peripheral devices capable of being used by a merchant to conduct a transaction with a user. For example, merchant system 108 may include a POS device and/or a POS system.

Acquirer system 110 may include one or more devices capable of receiving information from and/or transmitting information to transaction service provider system 102, issuer system 104, user device 106, and/or merchant system 108 via network 112. For example, acquirer system 110 may include a computing device, a server, a group of servers, and/or the like. In some non-limiting embodiments, acquirer system 110 may be associated with an acquirer as described herein.

Network 112 may include one or more wired and/or wireless networks. For example, network 112 may include a cellular network (e.g., a long-term evolution (LTE) network, a third generation (3G) network, a fourth generation (4G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of devices and networks shown in FIG. 1 are provided as an example. There may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally or alternatively, a set of devices (e.g., one or more devices) of environment 100 may perform one or more functions described as being performed by another set of devices of environment 100.

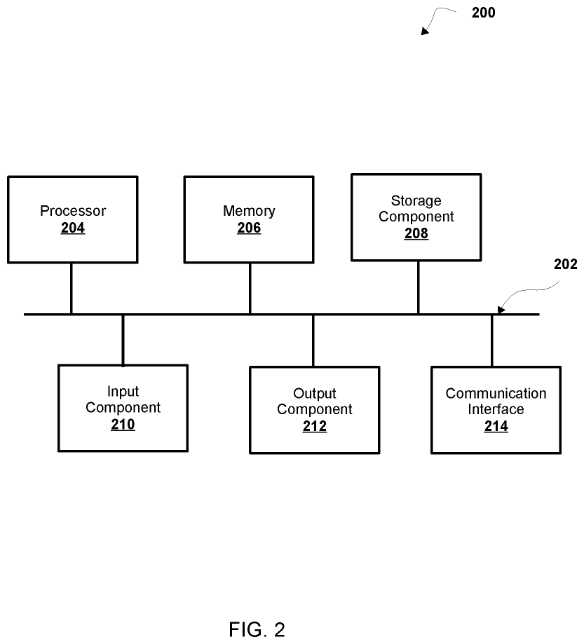

Referring now to FIG. 2, FIG. 2 is a diagram of example components of a device 200. Device 200 may correspond to one or more devices of transaction service provider system 102, and/or one or more devices of issuer system 104, user device 106, one or more devices of merchant system 108, and/or one or more devices of acquirer system 110. In some non-limiting embodiments, transaction service provider system 102, issuer system 104, user device 106, merchant system 108, and/or acquirer system 110 may include at least one device 200 and/or at least one component of device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting embodiments, processor 204 may be implemented in hardware, firmware, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read only memory (ROM), and/or another type of dynamic or static storage device (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments described herein are not limited to any specific combination of hardware circuitry and software.

The number and arrangement of components shown in FIG. 2 are provided as an example. In some non-limiting embodiments, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

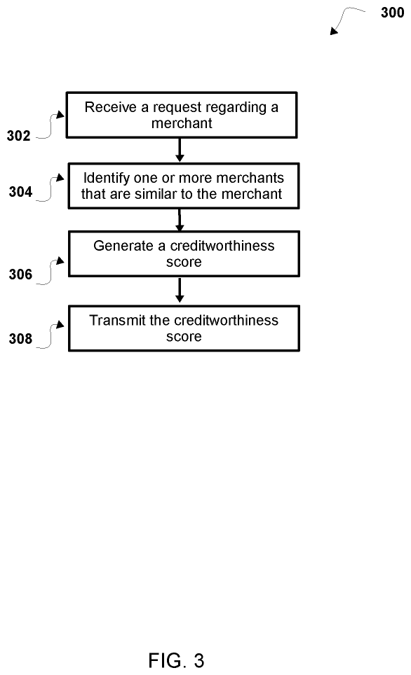

Referring now to FIG. 3, FIG. 3 is a flowchart of a non-limiting embodiment of a process 300 for determining a creditworthiness score of a merchant based on one or more similar merchants. In some non-limiting embodiments, one or more of the steps of process 300 may be performed (e.g., completely, partially, etc.) by transaction service provider system 102 (e.g., one or more devices of transaction service provider system 102). In some non-limiting embodiments, one or more of the steps of process 300 may be performed (e.g., completely, partially, etc.) by another device or a group of devices separate from or including transaction service provider system 102, such as issuer system 104 (e.g., one or more devices of issuer system 104), user device 106, merchant system 108 (e.g., one or more devices of merchant system 108), or acquirer system 110 (e.g., one or more devices of acquirer system 110).

As shown in FIG. 3, at step 302, process 300 includes receiving a request regarding a merchant. For example, transaction service provider system 102 may receive the request regarding the merchant from a financial services entity (e.g., a financial institution such as, acquirer system 110 or issuer system 104, a Fintech, and/or the like) that is associated with a financial product request (e.g., a loan request) for the merchant. In some non-limiting embodiments,

In some non-limiting embodiments, the request may include a request for a creditworthiness score associated with the merchant as part of the financial product request for the merchant. In some non-limiting embodiments, the request may include merchant data associated with the merchant to determine a creditworthiness score associated with the merchant. For example, the request may include data associated with an identification (e.g., an identity, a name, phone number, tax identification number, a merchant location identification number, and/or the like) of the merchant, data associated with a time interval (e.g., a time period, a time duration, a month, 12 months, and/or the like) during which the merchant has been active, data associated with a merchant type of the merchant, data associated with a merchant location of the merchant, data associated with a total transaction amount of a plurality of payment transactions conducted over a time interval that involve the merchant, data associated with a number of payment transactions conducted over a time interval that involve the merchant, and/or data associated with an average transaction amount of a plurality of payment transactions that involve the merchant.

In some non-limiting embodiments, transaction service provider system 102 may create a merchant profile for a merchant based on the merchant data associated with the merchant. For example, transaction service provider system 102 may create the merchant profile for that merchant that includes data associated with a time interval (e.g., a time period, a time duration, a month, 12 months, and/or the like) during which the merchant has been active, data associated with a merchant type of the merchant, data associated with a merchant location of the merchant, data associated with a total transaction amount of a plurality of payment transactions conducted over a time interval that involve the merchant, data associated with a number of payment transactions conducted over a time interval that involve the merchant, and/or data associated with an average transaction amount of a plurality of payment transactions that involve the merchant. In some non-limiting embodiments, transaction service provider system 102 may create the merchant profile for the merchant based on a request regarding the merchant.

In some non-limiting embodiments, transaction service provider system 102 may receive merchant data associated with a plurality of merchants before receiving the request regarding the merchant. For example, transaction service provider system 102 may receive merchant data associated with a plurality of merchants (e.g., a merchant associated with merchant system 108, a plurality of merchants associated with a plurality of merchant systems 108, and/or the like). In some non-limiting embodiments, the merchant data associated with the plurality of merchants may include data associated with a time interval (e.g., a time period, a time duration, a month, 12 months, and/or the like) during which each of the plurality of merchants have been active (e.g., been in operation), data associated with a merchant type (e.g., a merchant category, a merchant category code (MCC), and/or the like) of each of the plurality of merchants, and/or data associated with a merchant location (e.g., an address of a merchant location, GPS coordinates of a merchant location, and/or the like) of each of the plurality of merchants.

Additionally or alternatively, the merchant data associated with the plurality of merchants may include data associated with a total transaction amount of a plurality of payment transactions conducted over a time interval (e.g., a weekly sales volume, a monthly sales volume, a yearly sales volume, and/or the like) that involve a merchant of the plurality of merchants, data associated with a number of payment transactions conducted over a time interval (e.g., a weekly transaction volume, a monthly transaction volume, a yearly transaction volume, and/or the like) that involve a merchant of the plurality of merchants, data associated with an average transaction amount of a plurality of payment transactions (e.g., an average purchase amount) that involve a merchant of the plurality of merchants, data associated with a type of payment device (e.g., a credit card, a debit card, an affluent type of credit card, and/or the like) used in each of a plurality of payment transactions that involve a merchant of the plurality of merchants, data associated with a growth rate of the total transaction amount of a plurality of payment transactions conducted over a time interval (e.g., a weekly sales growth rate, a monthly sales growth rate, a yearly sales growth rate, and/or the like) that involve a merchant of the plurality of merchants, data associated with a growth rate of a number of payment transactions conducted over a time interval (e.g., a growth rate of weekly transaction volume, a growth rate of monthly transaction volume, a growth rate of yearly transaction volume, and/or the like) that involve a merchant of the plurality of merchants, a percentage of a plurality of payment transactions that involve a merchant of the plurality of merchants that are disputed payment transactions, data associated with a percentage of a plurality of payment transactions that involve a merchant of the plurality of merchants that are fraudulent payment transactions (e.g., determined to be fraudulent payment transactions), data associated with a percentage of a plurality of payment transactions that involve a merchant of the plurality of merchants that are declined payment transactions, data associated with a percentage of a plurality of payment transactions that involve a merchant of the plurality of merchants that are approved payment transactions, data associated with a customer churn rate associated with customers that conducted payment transactions involving a merchant of the plurality of merchants, data associated with a percentage of payment transactions that involve a merchant of the plurality of merchants that involve a unique account identifier of an account of a customer, and/or data associated with a percentage of payment transactions that involve a merchant of the plurality of merchants that involve a repeating account identifier of an account of a customer.

In some non-limiting embodiments, transaction service provider system 102 may receive the merchant data associated with the plurality of merchants from one or more issuer systems 104 and/or one or more acquirer systems 110. For example, transaction service provider system 102 may receive the merchant data associated with the plurality of merchants from one or more issuer systems 104 and/or one or more acquirer systems 110 that have processed one or more payment transactions involving the plurality of merchants. In some non-limiting embodiments, transaction service provider system 102 may store the merchant data associated with the plurality of merchants in a data structure such that merchant data associated with the plurality of merchants is able to be retrieved (e.g., based on an API call) for each merchant of the plurality of merchants.

As further shown in FIG. 3, at step 304, process 300 includes identifying one or more merchants that are similar to the merchant. For example, transaction service provider system 102 may identify one or more second merchants that are similar to a first merchant based on a threshold. In some non-limiting embodiments, transaction service provider system 102 may identify the one or more second merchants that are similar to the first merchant based on a threshold of time during which the one or more second merchants has been active, a threshold merchant type (e.g., an MCC of the first merchant, an MCC that is similar to the MCC of the first merchant, and/or the like) of the one or more second merchants, a threshold of distance of a merchant location of the one or more second merchants from a location associated with the merchant location of the first merchant, a threshold of an average transaction amount of payment transactions involving the one or more second merchants during a time interval, a threshold of a number of payment transactions involving the one or more second merchants during a time interval, and/or a threshold of an overall transaction amount of payment transactions involving the one or more second merchants during a time interval. For example, transaction service provider system 102 may identify the one or more second merchants that are similar to the first merchant based on a threshold by comparing merchant data associated with the one or more second merchants to the threshold. If the one or more second merchants correspond to the threshold, transaction service provider system 102 may determine that the one or more second merchants are similar to the first merchant. If the one or more second merchants do not correspond to the threshold, transaction service provider system 102 may determine that the one or more second merchants are not similar to the first merchant.

In some non-limiting embodiments, transaction service provider system 102 may determine the threshold based on the merchant data associated with the first merchant. For example, transaction service provider system 102 may determine the threshold based on the merchant data associated with the first merchant included in a merchant profile for the first merchant.

In some non-limiting embodiments, the threshold may include a parameter based on merchant data associated with the first merchant. For example, the parameter may be based on (e.g., may include a value of, may include a range of values of, and/or the like) a total transaction amount of a plurality of payment transactions conducted over a time interval, a number of payment transactions conducted over a time interval, an average transaction amount of a plurality of payment transactions, a type of payment device used in each of a plurality of payment transactions, a growth rate of the total transaction amount of a plurality of payment transactions conducted over a time interval, a growth rate of a number of payment transactions conducted over a time interval, a percentage of a plurality of payment transactions, a percentage of a plurality of payment transactions that are fraudulent payment transactions, a percentage of a plurality of payment transactions that are declined payment transactions, a percentage of a plurality of payment transactions that are approved payment transactions, a customer churn rate associated with customers that conducted payment transactions, a percentage of payment transactions that involve a unique account identifier of an account of a customer, and/or a percentage of payment transactions that involve a repeating account identifier of an account of a customer.

In some non-limiting embodiments, transaction service provider system 102 may retrieve (e.g., based on an API call) the merchant data associated with one or more second merchants that correspond to the threshold. For example, transaction service provider system 102 may retrieve the merchant data associated with the one or more merchants from a data structure associated with transaction service provider system 102 based on determining that the one or more second merchants satisfy the threshold. In some non-limiting embodiments, transaction service provider system 102 may retrieve merchant data associated with the first merchant based on a request regarding the first merchant received from a financial services entity (e.g., acquirer system 110). For example, transaction service provider system 102 may receive a request from the financial institution that is associated with a financial product request for the first merchant (e.g., a request for a financial product to be provided to the first merchant) and transaction service provider system 102 may retrieve the merchant data associated with the first merchant based on the request.

In some non-limiting embodiments, transaction service provider system 102 may identify the one or more second merchants that are similar to the first merchant based on a merchant profile for the first merchant. For example, transaction service provider system 102 may identify the one or more second merchants that are similar to the first merchant based on merchant data associated with the first merchant included in the merchant profile. In some non-limiting embodiments, transaction service provider system 102 may identify the one or more second merchants based on determining that the one or more second merchants correspond to the merchant data associated with the first merchant included in the merchant profile.

As further shown in FIG. 3, at step 306, process 300 includes generating a creditworthiness score. For example, transaction service provider system 102 may generate a creditworthiness score of one or more second merchants that were identified as being similar to a first merchant. In some non-limiting embodiments, transaction service provider system 102 may generate the creditworthiness score of the one or more second merchants based on merchant data associated with the one or more second merchants. In one example, transaction service provider system 102 may generate the creditworthiness score of the one or more second merchants based on data associated with payment flows for a time interval (e.g., annual and/or quarterly) of the one or more second merchants, data associated with chargebacks of the one or more second merchants, data associated with order frequency and/or stability of a merchant that is a partner (e.g., a merchant partner) of the one or more second merchants, data associated with an existing line of credit with a supplier of the one or more second merchants, data associated with payment performance with a supplier (e.g., tardiness, default, fraud, returns, and/or the like) of the one or more second merchants, data associated with a fraud rate of the one or more second merchants, data associated with a growth rate of the one or more second merchants, data associated with a default rate of the one or more second merchants, and/or data associated with a payment behavior of the one or more second merchants.

In some non-limiting embodiments, transaction service provider system 102 may generate a creditworthiness score for the first merchant. For example, transaction service provider system 102 may generate the creditworthiness score for the first merchant based on the creditworthiness score of the one or more second merchants.

As further shown in FIG. 3, at step 308, process 300 includes transmitting the creditworthiness score. For example, transaction service provider system 102 may communicate the information associated with the creditworthiness score of the one or more second merchants to a computer device.

In some non-limiting embodiments, transaction service provider system 102 may communicate a report that includes the information associated with the creditworthiness score of the one or more second merchants and/or information associated with a creditworthiness score of the first merchant. For example, transaction service provider system 102 may communicate a report that includes the information associated with the creditworthiness score of the one or more second merchants and/or information associated with a creditworthiness score of the first merchant to acquirer system 110, merchant system 108, user device 106, and/or issuer system 104. In some non-limiting embodiments, the report may include a recommendation, such as a recommendation for approval of a financial product, decline of a financial product, and/or increase of a loan amount. The recommendation may be based on a financial product type, such as a recommendation based on a pre-paid credit card, a business credit card, and/or a loan.

In some non-limiting embodiments, transaction service provider system 102 may monitor an account of the first merchant. For example, transaction service provider system 102 may monitor the account of the first merchant to provide information associated with the first merchant's performance and potential problems, information associated with a risk of increasing the first merchant's credit limit, and/or to revalidate merchant data associated with the first merchant to maintain an accuracy level of a model associated with the first merchant.

Some non-limiting embodiments are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, and/or the like.

Although the present disclosure has been described in detail for the purpose of illustration based on what is currently considered to be the most practical and preferred embodiments, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed is:

1. A computer-implemented method for determining a creditworthiness score of a merchant based on one or more similar merchants comprising:
receiving, with at least one processor, a request regarding a first merchant;
identifying, with at least one processor, one or more second merchants that are similar to the first merchant based on a threshold;
generating, with at least one processor, a creditworthiness score of the one or more second merchants based on merchant creditworthiness data associated with payment transactions involving the one or more second merchants; and
transmitting, with at least one processor, information associated with the creditworthiness score of the one or more second merchants to a computer device.

2. The method of claim 1, wherein the merchant data associated with the first merchant comprises:
data associated with a time interval during which the first merchant has been active;
data associated with a merchant type of the first merchant;
data associated with a merchant location of the first merchant;
data associated with an average transaction amount of payment transactions involving the first merchant;
data associated with a number of payment transactions involving the first merchant during the time interval;
data associated with an overall transaction amount of payment transactions involving the first merchant during the time interval; or
any combination thereof.

3. The method of claim 1, wherein the merchant creditworthiness data comprises:
data associated with payment flows of the one or more second merchants;
data associated with chargebacks of the one or more second merchants;
data associated with a fraud rate of the one or more second merchants;
data associated with a growth rate of the one or more second merchants;
data associated with a default rate of the one or more second merchants;
data associated with a payment behavior of the one or more second merchants; or
any combination thereof.

4. The method of claim 1, wherein receiving the merchant data associated with the first merchant comprises:
retrieving the merchant data associated with the first merchant from a database associated with a transaction service provider system.

5. The method of claim 1, further comprising:
generating a creditworthiness score for the first merchant based at least partially on the creditworthiness score of the one or more second merchants.

6. The method of claim 1, wherein identifying the one or more second merchants that are similar to the first merchant based on the threshold comprises:
identifying the one or more second merchants that are similar to the first merchant based on at least one of the following:
a threshold of time during which the one or more second merchants has been active;
a threshold merchant type of the one or more second merchants;
a threshold of distance of a merchant location of the one or more second merchants from a location associated with the merchant location of the first merchant;
a threshold of an average transaction amount of payment transactions involving the one or more second merchants during a time interval;
a threshold of a number of payment transactions involving the one or more second merchants during a time interval; or
a threshold of an overall transaction amount of payment transactions involving the one or more second merchants during a time interval.

7. The method of claim 6, further comprising:
determining, based on the merchant data associated with the first merchant, at least one the following:
the threshold of time during which the one or more second merchants has been active;
the threshold merchant type of the one or more second merchants;
the threshold of distance of the merchant location of the one or more second merchants from the location associated with the merchant location of the first merchant;
the threshold of an average transaction amount of payment transactions involving the one or more second merchants during a time interval;
the threshold of a number of payment transactions involving the one or more second merchants during a time interval; or
the threshold of the overall transaction amount of payment transactions involving the one or more second merchants during a time interval.

8. A system for determining a creditworthiness score of a merchant based on one or more similar merchants comprising:
at least one processor programmed or configured to:
receive merchant data associated with a first merchant;
identify one or more second merchants that are similar to the first merchant;
generate a creditworthiness score of the one or more second merchants based on merchant creditworthiness data associated with payment transactions involving the one or more second merchants; and
transmit information associated with the creditworthiness score of the one or more second merchants to a computer device.

9. The system of claim 8, wherein the merchant data associated with the first merchant comprises:
data associated with a time interval during which the first merchant has been active;
data associated with a merchant type of the first merchant;
data associated with a merchant location of the first merchant;
data associated with an average transaction amount of payment transactions involving the first merchant;
data associated with a number of payment transactions involving the first merchant during the time interval;
data associated with an overall transaction amount of payment transactions involving the first merchant during the time interval; or
any combination thereof.

10. The system of claim 8, wherein the merchant creditworthiness data comprises:
data associated with payment flows of the one or more second merchants;
data associated with chargebacks of the one or more second merchants;
data associated with a fraud rate of the one or more second merchants;
data associated with a growth rate of the one or more second merchants;
data associated with a default rate of the one or more second merchants;
data associated with a payment behavior of the one or more second merchants; or
any combination thereof.

11. The system of claim 8, wherein, when receiving the merchant data associated with the first merchant, the at least one processor is programmed or configured to:
retrieve the merchant data associated with the first merchant from a database associated with a transaction service provider system.

12. The system of claim 8, wherein the at least one processor is further programmed or configured to:
generate a creditworthiness score for the first merchant based at least partially on the creditworthiness score of the one or more second merchants.

13. The system of claim 8, wherein, when identifying the one or more second merchants that are similar to the first merchant, the at least one processor is programmed or configured to:
identify the one or more second merchants that are similar to the first merchant based on at least one of the following:
a threshold of time during which the one or more second merchants has been active;
a threshold merchant type of the one or more second merchants;
a threshold of distance of a merchant location of the one or more second merchants from a location associated with the merchant location of the first merchant;
a threshold of an average transaction amount of payment transactions involving the one or more second merchants during a time interval;
a threshold of a number of payment transactions involving the one or more second merchants during a time interval; or
a threshold of an overall transaction amount of payment transactions involving the one or more second merchants during a time interval.

14. The system of claim 13, wherein the at least one processor is further programmed or configured to:
determine, based on the merchant data associated with the first merchant, at least one the following:
the threshold of time during which the one or more second merchants has been active;
the threshold merchant type of the one or more second merchants;
the threshold of distance of the merchant location of the one or more second merchants from the location associated with the merchant location of the first merchant;
the threshold of an average transaction amount of payment transactions involving the one or more second merchants during a time interval;
the threshold of a number of payment transactions involving the one or more second merchants during a time interval; or
the threshold of the overall transaction amount of payment transactions involving the one or more second merchants during a time interval.

15. A computer program product for determining a creditworthiness score of a merchant based on one or more similar merchants comprising at least one non-transitory computer-readable medium comprising one or more instructions that, when executed by at least one processor, cause the at least one processor to:
identify one or more second merchants that are similar to a first merchant;
generate a creditworthiness score of the one or more second merchants based on merchant creditworthiness data associated with payment transactions involving the one or more second merchants; and
transmit information associated with the creditworthiness score of the one or more second merchants to a computer device.

16. The computer program product of claim 15, wherein, the one or more instructions that cause the at least one processor to receive the merchant data associated with the first merchant, cause the at least one processor to:
retrieve the merchant data associated with the first merchant from a database associated with a transaction service provider system.

17. The computer program product of claim 15, wherein the one or more instructions further cause the at least one processor to:
generate a creditworthiness score for the first merchant based at least partially on the creditworthiness score of the one or more second merchants.

18. The computer program product of claim 15, wherein, the one or more instructions that cause the at least one processor to identify the one or more second merchants that are similar to the first merchant, cause the at least one processor to:
identify the one or more second merchants that are similar to the first merchant based on at least one of the following:
a threshold of time during which the one or more second merchants has been active;
a threshold merchant type of the one or more second merchants;
a threshold of distance of a merchant location of the one or more second merchants from a location associated with the merchant location of the first merchant;
a threshold of an average transaction amount of payment transactions involving the one or more second merchants during a time interval;
a threshold of a number of payment transactions involving the one or more second merchants during a time interval; or
a threshold of an overall transaction amount of payment transactions involving the one or more second merchants during a time interval.

19. The computer program product of claim 18, wherein the one or more instructions further cause the at least one processor to:
determine, based on the merchant data associated with the first merchant, at least one the following:
the threshold of time during which the one or more second merchants has been active;
the threshold merchant type of the one or more second merchants;
the threshold of distance of the merchant location of the one or more second merchants from the location associated with the merchant location of the first merchant;
the threshold of an average transaction amount of payment transactions involving the one or more second merchants during a time interval;
the threshold of a number of payment transactions involving the one or more second merchants during a time interval; or
the threshold of the overall transaction amount of payment transactions involving the one or more second merchants during a time interval.

20. The computer program product of claim 15, wherein the merchant data associated with the first merchant comprises:
data associated with a time interval during which the first merchant has been active;
data associated with a merchant type of the first merchant;
data associated with a merchant location of the first merchant;
data associated with an average transaction amount of payment transactions involving the first merchant;
data associated with a number of payment transactions involving the first merchant during the time interval;
data associated with an overall transaction amount of payment transactions involving the first merchant during the time interval; or
any combination thereof.
